(19) United States
(12) Patent Application Publication
(10) Pub. No.: US 2002/0051697 A1
(43) Pub. Date: May 2, 2002

(54) Removable gripper pads

(76) Inventors: Alexander Sou-Kang Ko, Sunnyvale, CA (US); Donald Olgado, Palo Alto, CA (US)

Correspondence Address: PATENT COUNSEL, APPLIED MATERIALS, INC., Legal Affairs Department, P.O. BOX 450A, Santa Clara, CA, 95052, US

(21) Appl. No.: 09/895,436

(22) Filed: Jun. 30, 2001

Related U.S. Application Data
(60) Provisional application No. 60/216,917, filed on Jul. 8, 2000.

(51) Int. Cl. B66C 17/08

(52) U.S. Cl. 414/193; 118/676

(57) ABSTRACT

A rotateable substrate support having a rotateable base and a plurality of end effectors coupled to the rotateable base, and adapted to support a substrate. Each end effector has a removable finger extending from the rotateable base and adapted to contact an edge of a substrate supported by the plurality of end effectors, and/or a removable pad, removably coupled to a finger, and positioned so as to contact an edge of a substrate supported by the plurality of end effectors.

This application claims priority from U.S. Provisional Patent Application Ser. No. 60/216,917, filed Jul. 8, 2000, which is hereby incorporated by reference herein in its entirety.

### FIELD OF THE INVENTION

The invention relates to the cleaning and drying of thin disks such as glass substrates, flat panel displays, patterned or unpatterned semiconductor substrates, and the like. More specifically, the present invention relates to an improved spin-rinse-dryer for rinsing and drying semiconductor substrates.

### BACKGROUND OF THE INVENTION

Semiconductor substrates are often cleaned within a tank of fluid (or a bath) followed by a rinsing process (e.g., by submersing the substrate in rinsing fluid, or by spraying the substrate with rinsing fluid). A drying apparatus such as a spin-rinse-dryer (SRD) is typically used to rinse and to dry a substrate.

Spin-rinse-dryers typically include a rotateable base having a plurality of end effectors coupled thereto. The end effectors are adapted to support a substrate by contacting the edges thereof. During substrate rotation, the contact between an edge of a substrate and the end effector may cause the end effector to wear. Such wear may require frequent end effector replacement, which may increase substrate cleaning costs.

Accordingly, a need exists for an improved end effector that requires less replacement than do conventional end effectors.

### SUMMARY OF THE INVENTION

An improved end effector comprises a removable pad, removably coupled to a finger and positioned so as to contact an edge of a substrate, or, comprises a finger positioned so as to contact an edge of a substrate, and removably coupled to a base that is adapted to be coupled to a rotateable substrate support (e.g., a flywheel). The base may further comprise a clamp for clamping the edge of a substrate supported by the rotateable substrate support.

Other features and aspects of the present invention will become more fully apparent from the following detailed description of the preferred embodiments, the appended claims and the accompanying drawings.

### BRIEF DESCRIPTION OF THE PREFERRED EMBODIMENTS

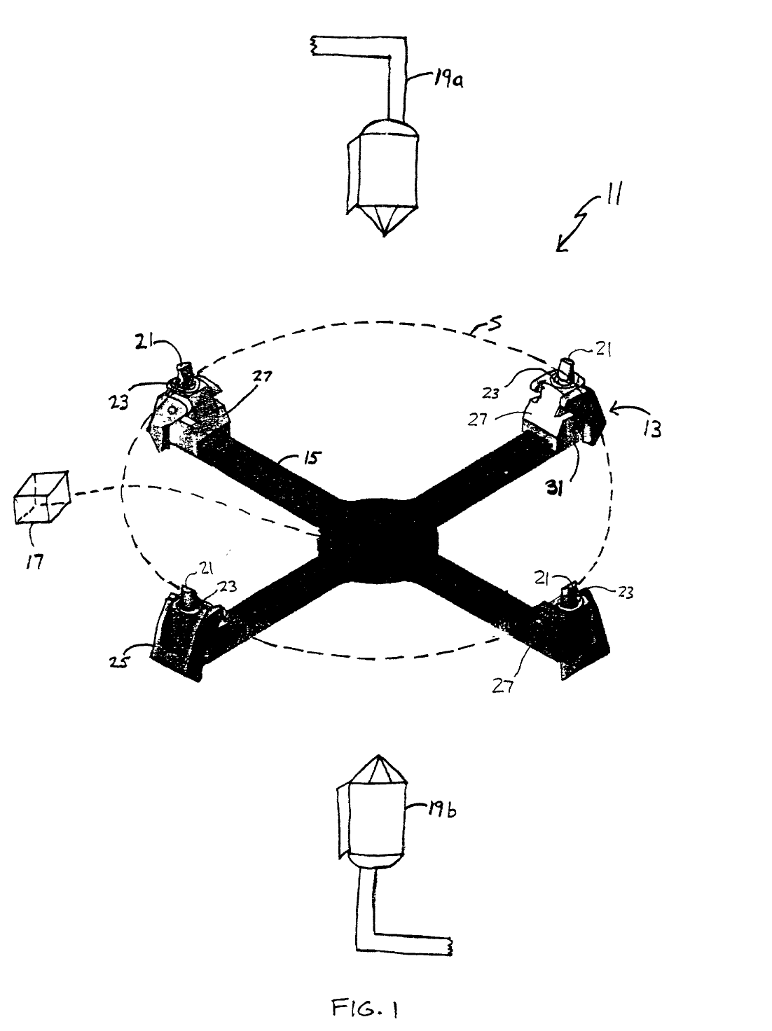

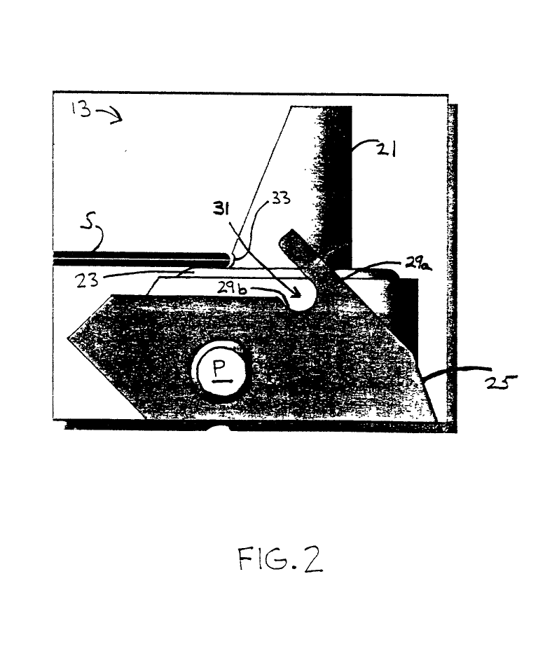

FIG. 1 is a top perspective view of a drying apparatus adapted to rinse, spin, and dry a substrate and having a plurality of end effectors;

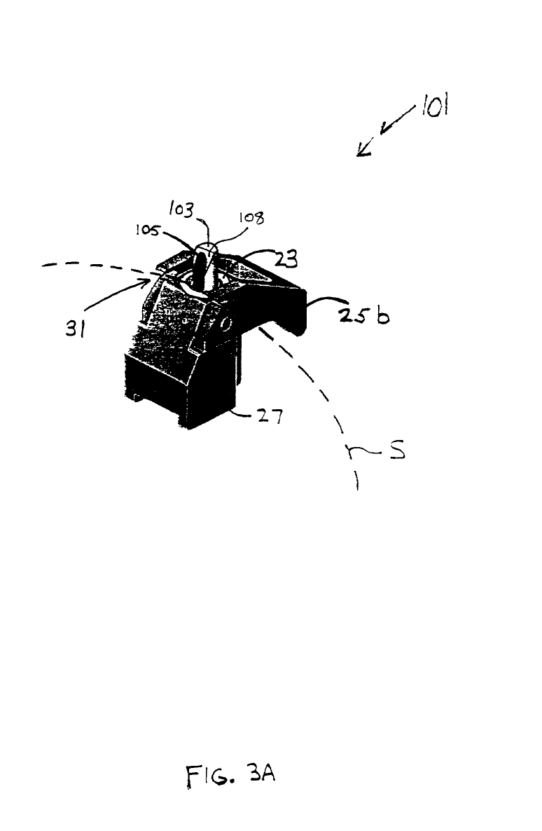

FIG. 2 is a close-up side elevational view of an end effector of FIG. 1, showing a groove caused by contact between the edge of a substrate and the end effector as the substrate rotates;

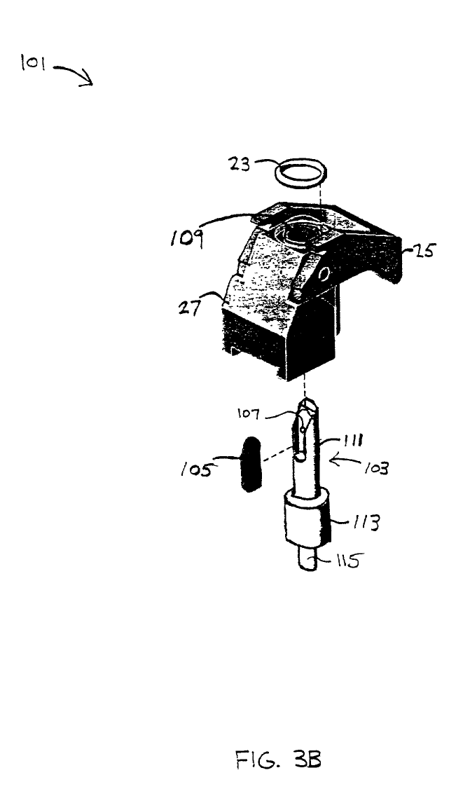

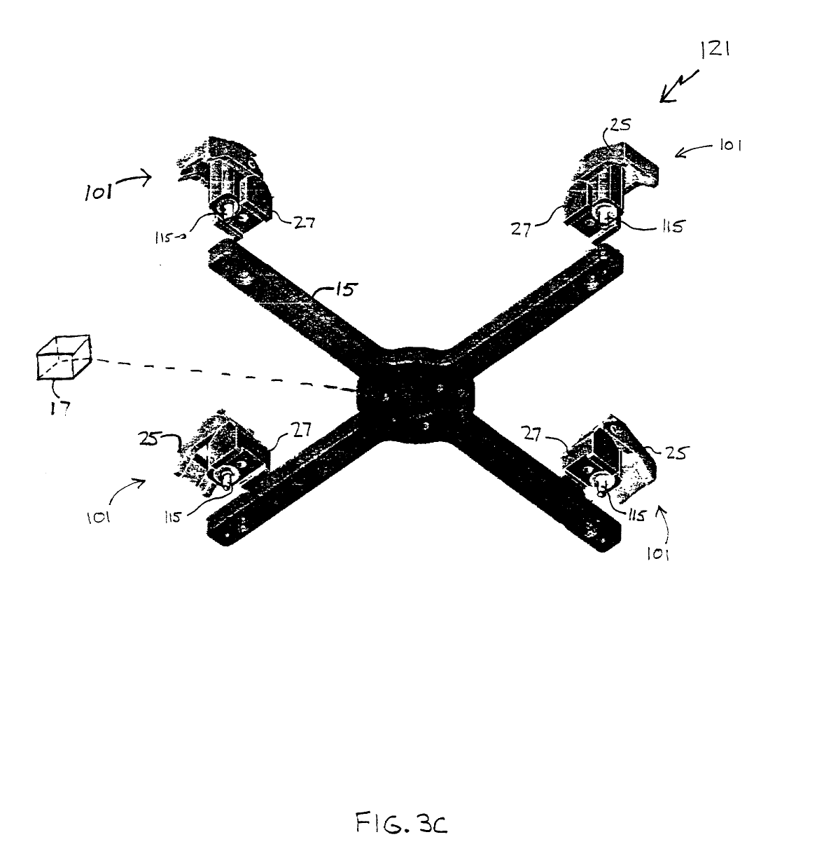

FIG. 3A is a side perspective view of an inventive end effector;

FIG. 3B is an exploded side perspective view of a finger removed from the base unit of the inventive end effector of FIG. 3A; and

FIG. 3C is an exploded bottom perspective view of a drying apparatus having a plurality of the inventive end effectors of FIGS. 3A and 3B.

### DETAILED DESCRIPTION OF THE PREFERRED EMBODIMENTS

An inventive end effector is provided. The inventive end effector may require less frequent replacement than do conventional end effectors and may result in less maintenance and repair time. To fully understand the advantages of the inventive end effector, a drying apparatus having a plurality of conventional end effectors is shown and described with reference to FIG. 1.

FIG. 1 is a top perspective view of a drying apparatus 11 adapted to spin, rinse, and dry (a spin-rinse-dryer (SRD)) a substrate S. The drying apparatus 11, as shown in FIG. 1, comprises a plurality of conventional end effectors 13 adapted to support a substrate S with minimal contact so as to avoid trapping fluid on the substrate S, as is conventionally known in the art. The plurality of end effectors 13 are coupled to a rotateable base 15, that is adapted to spin a substrate S. The rotateable base 15 may comprise a rotateable flywheel as shown. A motor 17 is coupled to the rotateable base 15 and is adapted to control the operational speed thereof. The drying apparatus 11 may include a pair of rinsing nozzles 19a, 19b that are coupled to a source of rinsing fluid (not shown), and are positioned to supply rinsing fluid to the center of the front and back surfaces of the substrate S, respectively.

Each end effector 13 comprises a finger 21, adapted to contact an edge of a substrate S, and an O-ring 23, which surrounds the finger 21 such that an edge of a substrate S may be positioned on a portion of the O-ring 23. The finger 21 and the O-ring 23 are best seen in FIG. 2, which is a close-up side elevational view of one of the end effectors 13. Typically, the finger 21 comprises a plastic material. Each end effector 13 further comprises a clamp 25, adapted to clamp an edge of a substrate S, and a base unit 27, to which the finger 21, the O-ring 23, and the clamp 25 are coupled. The clamp 25 comprises two regions 29a, 29b which are configured to form a pocket 31, adapted to support the substrate S therein. The clamp 25 is pivotally mounted to the base unit 27 via a pivotal joint P. The clamp 25 is configured so that absent centrifugal force, the clamp will pivot (e.g., due to gravity) to a position wherein the pocket 31 is not parallel to the surface of a substrate S supported by the end effector (e.g., a perpendicular orientation).

As the rotateable base 15 rotates, centrifugal force causes the clamp 25 to move outward from the center of rotation. In turn, the clamp 25 may pivot from a perpendicular orientation (shown by clamp 25 in FIGS. 1 and 2) to a parallel orientation (shown by clamp 25b (FIG. 3A)) so as to clamp an edge of a substrate S supported by the plurality of end effectors 13. In the parallel orientation, the pocket 31 is parallel to a major surface of a substrate S.

In operation, a substrate handler (not shown) places a substrate S on the rotateable base 15. An edge of the substrate S is positioned on a portion of the O-ring 23. The O-ring 23 may have a convex surface so as to minimize contact with the substrate S and to reduce the trapping of fluid against the substrate S. Because the clamp 25 is initially in the perpendicular orientation due to gravity (FIG. 1), as the rotateable base 15 begins to rotate, centrifugal force causes the clamp 25 to pivot from the perpendicular orientation (FIG. 1) to the parallel orientation (FIG. 3A) so as to clamp the edge of the substrate S. In the parallel orientation, the edge of the substrate S is positioned in the pocket 31 of the clamp 25.

The rotateable base 15 initially rotates at a slow speed (e.g., 100 to 500 revolutions per minute (rpm)) while the rinsing fluid nozzles 19a, 19b supply rinsing fluid to the center of the front and back surfaces of the substrate S. After the substrate S is sufficiently rinsed (e.g., approximately 12 seconds), the rinsing fluid nozzles 19a, 19b shut off and the motor 17 increases the rotational speed of the rotateable base 15 (e.g., to approximately 1000 to 2500 rpm) such that rinsing fluid is displaced from the substrate S via the increased rotational speed, and/or dried from the substrate S.

The increased rotational speed of the rotateable base 15 is sufficient such that the resulting centrifugal force displaces fluid from the surfaces of the substrate S. As the substrate S rotates, however, the substrate S contacts the finger 21. The contact between the edge of the substrate S and the finger 21 may cause the finger 21 to wear as described below with reference to FIG. 2.

After the substrate S is sufficiently dry, the motor 17 stops the rotateable base 15 from rotating. Because the rotateable base is no longer rotating, centrifugal force is no longer exerted on the clamps 25, and the clamps 25 again assume the parallel orientation (due to the gravitational force exerted thereon). Thus, the substrate S is unclamped, and a substrate handler (not shown) may extract the rinsed and dried substrate S from the rotateable base 15.

With reference to FIG. 2, wear caused by contact between the edge of a substrate S and the finger 21 as the substrate S rotates is shown. As previously described, during the operation of the drying apparatus 11 (FIG. 1), the edge of the substrate S contacts the finger 21. The substrate S may vibrate or may slip along the finger 21. Such contact causes the finger 21 to wear, eventually resulting in a groove 33. For example, after the drying apparatus 11 dries approximately two thousand substrates, a groove 33 may form in the finger 21. Thereafter, subsequent rinsed and dried substrate S may enter the groove 33 and become trapped (as shown in FIG. 2).

After the rotateable base 15 stops rotating and the substrate handler (not shown) extracts the substrate S from the rotateable base 15, the trapped portion of the substrate S may chip via contact with the groove 33 of the finger 21. Alternatively, the trapped portion of the substrate S may prevent the substrate handler from removing the substrate S from the rotateable base 15. Hence, the end effector 13 must be replaced frequently, which increases substrate processing costs. Accordingly, the present inventors have developed an improved end effector having either a replaceable finger removably coupled to the base and/or a replaceable pad that is located on the portion of the finger that is subject to wear caused by contact from the edge of a substrate S.

FIG. 3A is a side perspective view of a first aspect of an inventive end effector 101 that employs a replaceable pad; and FIG. 3B is an exploded view of the end effector 101. The inventive end effector 101 comprises a finger 103, adapted to contact an edge of a substrate S, and a replaceable pad 105, removably coupled to the finger 103 and positioned where the edge of a substrate S would otherwise contact the finger 103. The finger 103 may comprise a post as shown. The back portion of the finger 103 may comprise a hole 107 (FIG. 3B) positioned such that an object (e.g., a pin) may penetrate the hole 107 and push the replaceable pad 105 from the finger 103 to thereby facilitate removal of the pad 105. Preferably the finger 103 may comprise an alignment finger having an inwardly angled surface 108 adapted so as to align a substrate S as a substrate handler (not shown) places the substrate S on the rotateable base 15. As is known in the art, the alignment fingers may guide an off-centered substrate into a desired (e.g., centered) position between a plurality of alignment fingers. The alignment fingers thus create a capture window for the substrate S.

The replaceable pad 105 may comprise a wedge, positioned at a sloped angle such that the wedge may contact and aid in alignment of a substrate S. In one embodiment, the replaceable pad 105 comprises a material, such as silicon carbide, that has a wear resistance higher than that of plastic (i.e., a wear resistant material). Alternatively, the replaceable pad 105 may have a coating thereon of such a wear resistant material. A silicon carbide replaceable pad 105 has a wear resistance which is approximately 10 times the wear resistance of plastic.

The inventive end effector 101 may further comprise the O-ring 23 that surrounds the finger 103 such that an edge of a substrate S may be positioned on a portion on the O-ring 23. The inventive end effector 101 also may include the clamp 25, adapted to clamp an edge of a substrate S, and the base unit 27, to which the finger 103, the O-ring 23, the clamp 25, and the replaceable pad 105 are mounted. The finger 103 is positioned in an aperture 109 (FIG. 3B) of the base unit 27. The finger 103 preferably is removably coupled (e.g., via a threaded coupling, a tongue and groove coupling or simply via sizing the finger 103 so as to be firmly held in place by the aperture 109) to the base unit 27 as described below with reference to FIG. 3B.

With reference to FIG. 3B, the finger 103 is shown removed from the base unit 27 of the inventive end effector 101. The finger 103 comprises an elongated portion 111 with a thicker portion 113 toward the bottom of the finger 103. The thicker portion 113 prevents the finger 103 from sliding upward and out the top of the aperture 109. To remove the finger 103 from the base unit 27, the finger 103 is pushed vertically downward through the aperture 109 of the base unit 27 as shown in FIG. 3B.

A bottom pin portion 115 of the finger 103 of the end effector 101 may be configured to insert into the rotateable base 15 of FIG. 1. For example, FIG. 3C is an exploded bottom view of an inventive drying apparatus 121 having a plurality of the novel end effectors 101 coupled to the base 15 via the bottom pin portion 115 (e.g., via a plurality of holes (not shown)). The drying apparatus 121 may comprise the same components as the drying apparatus 11 of FIG. 1 while replacing the conventional end effector 13 with the inventive end effector 101. Accordingly, only those components of the inventive drying apparatus 121 that differ from the conventional drying apparatus 11 (FIG. 1) are described with reference to FIG. 3C. Within the drying apparatus 121, the finger 103 and the replaceable pad 105 are positioned perpendicular to a major surface of a substrate S (as shown in FIG. 3A). The replaceable pad 105 is also positioned so as to extend above and below the substrate S's major surface so that the substrate S may not contact a bottom edge of the replaceable pad 105 and be trapped thereby.

In operation, a substrate handler (not shown) positions a substrate S on the alignment fingers 103. The alignment fingers 103 align the substrate S as the substrate S slides therealong into position on the rotateable base 15. Once in position on the rotateable base 15, an edge of the substrate S is positioned on a portion of the O-ring 23. The clamp 25 is initially in the perpendicular orientation (as shown by the end effector of FIG. 2). As the rotateable base 15 begins to rotate, the clamp 25 pivots from the perpendicular orientation to the parallel orientation (as shown in FIG. 3A) so as to clamp the edge of a substrate S. When the clamp 25 is in the parallel orientation, the edge of the substrate S is positioned in the pocket 31 of the clamp 25, as previously described.

The rotateable base 15 initially rotates at a slow speed (e.g., 100 to 500 revolutions per minute (rpm)) while the rinsing fluid nozzles 19a, 19b (FIG. 1) supply rinsing fluid to the center of the front and back surfaces of the substrate S. After the substrate S is sufficiently rinsed (e.g., approximately 12 sec.), the rinsing fluid nozzles 19a, 19b (FIG. 1) shut off and the motor 17 increases the rotational speed of the rotateable base 15 (e.g., to approximately 1000 to 2500 rpm) such that rinsing fluid is displaced from the substrate S via the increased rotational speed, and/or dried from the substrate S. The increased rotational speed of the rotateable base 15 is sufficient such that the resulting centrifugal force displaces fluid from the surface of the substrate S.

After the substrate S is sufficiently dry, the motor 17 stops the rotateable base 15 from rotating, the clamps 25 again assume the perpendicular orientation such that the substrate S is unclamped. A substrate handler (not shown) may then extract the rinsed and dried substrate S from the rotateable base 15.

During the operation of the inventive drying apparatus 121, the edge of the substrate S contacts the replaceable pad 105. The substrate S may vibrate or may slip along the replaceable pad 105.

Because the replaceable pad 105 comprises a wear resistant material such as silicon carbide, the replaceable pad 105 wears more slowly than the finger 21 of the prior art, or the finger 103 of the inventive end effector. Test runs have shown that a groove forms in the replaceable pad 105 after the drying apparatus 121 dries approximately twenty thousand substrates. As stated previously, a groove 33 (FIG. 2) forms in a conventional end effector 13 after the drying apparatus 11 (FIG. 1) dries approximately two thousand substrates. Thus, the inventive end effector 101 reduces wear by an order of ten compared to conventional end effectors 13.

After a groove is created in the inventive end effector 101 (or just prior to creation of a groove), the replaceable pad 105 may be removed from the inventive end effector 101 by lifting the replaceable pad 105 from the finger 103, or in an embodiment having the hole 107, a pin may be inserted into the hole 107 and used to push the replaceable pad 105 from the finger 103. Another replaceable pad 105 then may be inserted into the finger 103. Alternatively, the finger 103 may be removed from the base unit 27 of the inventive end effector 101 by pushing the finger 103 vertically downward through the aperture 109 of the base unit 27. Another replaceable pad 105 may be inserted through the aperture 109 and held/wedged against the finger 103. The finger 103 is inserted into the aperture 109 of the base unit 27 by pushing the finger 103 vertically upward into the aperture 109 of the base unit 27.

The lifespan of the inventive end effector 101 may last much longer than the conventional end effector 11 (FIG. 1) because the area (i.e., the replaceable pad 105) of the inventive end effector 101 that is subject to wear caused by contact with the edge of a substrate S, may be replaced independently of the remainder of the inventive end effector 101 (e.g., independently of the base and/or the clamp).

The foregoing description discloses only the preferred embodiments of the invention, modifications of the above-disclosed apparatus and method which fall within the scope of the invention will be readily apparent to those of ordinary skill in the art. For example, instead of replacing the replaceable pad 105, the entire finger 103 may be replaced, and thus the replaceable pad may be omitted.

The aspects of the invention (e.g., the replaceable pad 105, the removable finger 103) are applicable to substrate spinners generally, and need not be limited to use on the SRD described herein, or may be employed within either a spin-rinser or a spin-drier. Thus, as used herein spinners include spin-rinsers and SRD's and spin-rinsers include apparatuses which spin and rinse, and which may or may not is include drying (SRD's). The aspects of the invention are applicable to spinners, spin rinsers or of any orientation (horizontal, vertical, etc.).

Accordingly, while the present invention has been disclosed in connection with the preferred embodiments thereof, it should be understood that other embodiments may fall within the spirit and scope of the invention, as defined by the following claims.

The invention claimed is:

1. A rotateable substrate support comprising:
a rotateable base:
a plurality of end effectors coupled to the rotateable base, adapted to support a substrate, each end effector comprising:
a finger extending from the rotateable base and adapted to contact an edge of a substrate supported by the plurality of end effectors, and
a removable pad, removably coupled to the finger, and positioned so as to contact an edge of a substrate supported by the plurality of end effectors.

2. The rotateable substrate support of claim 1 wherein each end effector further comprises a clamp, positioned adjacent the finger, adapted to clamp an edge of a substrate supported by the plurality of end effectors.

3. The rotateable substrate support of claim 2 wherein each end effector further comprises an O-ring, surrounding the finger, such that an edge of a substrate may be positioned on a portion of the O-ring.

4. The rotateable substrate support of claim 1 wherein the finger comprises an alignment finger adapted to align a substrate supported by the plurality of end effectors.

5. The rotateable substrate support of claim 4 wherein the removable pad is positioned perpendicular to a major surface of a substrate supported by the plurality of end effectors.

6. The rotateable substrate support of claim 5 wherein each end effector further comprises an O-ring, surrounding the finger, such that an edge of a substrate may be positioned on a portion of the O-ring.

7. The rotateable substrate support of claim 4 wherein each end effector further comprises a clamp, positioned adjacent the alignment finger, adapted to clamp an edge of a substrate supported by the plurality of end effectors.

8. The rotateable substrate support of claim 4 wherein the alignment finger is positioned at an inwardly angle such that the substrate may remain aligned.

9. The rotateable substrate support of claim 8 wherein the removable pad is positioned so as to contact an aligned substrate supported by the plurality of end effectors.

10. The rotateable substrate support of claim 9 wherein the removable pad is positioned perpendicular to a major surface of an aligned substrate supported by the plurality of end effectors.

11. The rotateable substrate support of claim 10 wherein the removable pad is positioned so as to extend above and below the substrate's major surface so that a substrate, supported by the plurality of end effectors, will not contact a bottom edge of the removable pad.

12. The rotateable substrate support of claim 1 wherein the removable pad is positioned perpendicular to a major surface of a substrate supported by the plurality of end effectors.

13. The rotateable substrate support of claim 12 wherein the removable pad comprises a material that has a wear resistance higher than that of plastic.

14. The rotateable substrate support of claim 12 wherein each end effector further comprises a clamp, positioned adjacent the finger, adapted to clamp an edge of a substrate supported by the plurality of end effectors.

15. The rotateable substrate support of claim 14 wherein the finger comprises an alignment finger adapted to align a substrate supported by the plurality of end effectors.

16. The rotateable substrate support of claim 15 wherein each end effector further comprises an O-ring, surrounding the finger, such that an edge of a substrate may be positioned on a portion of the O-ring.

17. The rotateable substrate support of claim 1 wherein the removable pad comprises a material that has a wear resistance higher than that of plastic.

18. The rotateable substrate support of claim 17 wherein the material comprises silicon carbide.

19. An end effector comprising:
a base;
a clamp, adapted to clamp an edge of a substrate supported by the end effector and coupled to the base; and
a finger, removably coupled to the base, adapted to contact an edge of a substrate supported by the end effector.

20. The end effector of claim 19 wherein the finger comprises an alignment finger adapted to align a substrate supported by the end effector.

21. The end effector of claim 20 wherein the alignment finger is positioned perpendicular to a major surface of a substrate.

22. The end effector of claim 19 wherein the finger is positioned perpendicular to a major surface of a substrate.

23. The end effector of claim 22 further comprising an O-ring, surrounding the finger, such that an edge of a substrate may be positioned on a portion of the O-ring.

24. An end effector comprising:
a finger adapted to support a substrate by the substrate's edge; and
a removable pad, removably coupled to the finger, and positioned so as to contact the edge of a substrate supported by the end effector.

25. The end effector of claim 24 wherein the finger comprises an alignment finger adapted to align a substrate supported by the end effector.

26. The end effector of claim 25 further comprising a clamp, positioned adjacent the alignment finger, adapted to clamp an edge of a substrate supported by the end effector.

27. The end effector of claim 26 wherein the removable pad is positioned perpendicular to a major surface of a substrate supported by the end effector.

28. The end effector of claim 25 wherein the removable pad is positioned at a sloped angle so as to align a substrate.

29. The end effector of claim 28 wherein the removable pad is positioned so as to extend above and below the substrate's major surface so that a substrate, supported by the end effector, will not contact a bottom edge of the removable pad.

30. The end effector of claim 25 wherein the removable pad is positioned perpendicular to a major surface of a substrate supported by the end effector.

31. The end effector of claim 24 further comprising a clamp, positioned adjacent the finger, adapted to clamp an edge of a substrate supported by the end effector.

32. The end effector of claim 31 further comprising an O-ring, surrounding the finger, such that an edge of a substrate may be positioned on a portion of the O-ring.

33. The end effector of claim 24 wherein the removable pad is positioned perpendicular to a major surface of a substrate supported by the end effector.

34. The end effector of claim 33 further comprising a clamp, positioned adjacent the finger, adapted to clamp an edge of a substrate supported by the end effector.
